(19) United States
(12) Patent Application Publication
(10) Pub. No.: US 2010/0062347 A1
(43) Pub. Date: Mar. 11, 2010

(54) RECHARGEABLE ZINC CELL WITH LONGITUDINALLY-FOLDED SEPARATOR

(76) Inventors: Lin-Feng Li, Croton-on-Hudson, NY (US); Fuyuan Ma, Yorktown Heights, NY (US); Zhenghao Wang, Beijing (CN)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/207,410

(22) Filed: Sep. 9, 2008

(51) Int. Cl. H01M 6/14; H01M 2/18; H01M 2/30; H01M 6/00; H01M 4/42

(52) U.S. Cl. 429/344; 429/246; 429/229; 429/178; 29/623.1

(57) ABSTRACT

A rechargeable zinc cell with a longitudinally-folded separator comprising a zinc negative electrode, a positive electrode, an electrolyte and a separator. The separator comprises at least two wicking layers with a microporous layer in the center thereof, and the separator is folded longitudinally to wrap around a long edge of the zinc negative electrode. A method of constructing a rechargeable zinc cell with a longitudinally-folded separator comprising the steps of placing the zinc negative electrode in contact with at least one of the two wicking layers of the separator, folding the separator longitudinally around a long edge of the zinc negative electrode, placing the positive electrode on said separator and rolling the zinc negative electrode, the positive electrode and the separator into a jelly roll structure.

### CROSS-REFERENCE TO RELATED APPLICATIONS

This application relates to a non-provisional U.S. Patent Application entitled “Non-Toxic Alkaline Electrolyte with Additives for Rechargeable Zinc Cells” by inventor Lin-Feng Li, and to a non-provisional U.S. Patent Application entitled “Polymer Membrane Utilized as a Separator in Rechargeable Zinc Cells” by inventor Lin-Feng Li, both filed concurrently, which applications are incorporated herein in their entirety by reference.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The preferred embodiment relates generally to a rechargeable zinc cell with a longitudinally-folded separator and method of use thereof, and more specifically a rechargeable zinc cell with a longitudinally-folded separator comprising a zinc negative electrode, a positive electrode, an electrolyte and a separator, wherein the separator comprises at least two wicking layers with a microporous layer in the center thereof, and wherein the separator is folded longitudinally to wrap around the zinc negative electrode, thereby improving cell cycle life and inhibiting dendrite growth.

2. Description of Related Art

The increase of environmental regulations, surging oil prices and the proliferation of electronic devices have given rise to new growing markets for battery and/or energy technologies. Batteries are well known in the art for supplying portable energy to electrical circuits and comprise four principal components: a negative electrode, a positive electrode, an electrolyte and a separator. The negative electrode provides electrons to an external electrical circuit (anodic reaction) during the discharge process. The positive electrode accepts electrons from the external circuit (cathodic reaction) during the discharge process. The separator keeps the negative electrode and the positive electrode insulated electrically, while the electrolyte disposed within the separator provides ionic conduction.

Currently, there exists a large variety of battery technologies, one of which is the nickel-cadmium battery. The nickel-cadmium battery comprises a nickel positive electrode that comprises primarily nickel hydroxide and a cadmium negative electrode that comprises primarily cadmium metal. During the discharge process, hydroxyl ions (OH⁻) in the electrolyte combine with the metallic cadmium (Cd) to form Cd(OH)₂ releasing the electrons to the external circuit via the negative electrode (anode, during discharge). Also during the discharge process, the positive electrode, or cathode, accepts electrons from the external circuit, thereby converting the charged nickel oxyhydroxide (NiOOH) to nickel hydroxide (Ni(OH)₂). There are several benefits associated with the nickel-cadmium battery. Such benefits include extended operating life, long storage life, and operation at both high and low temperatures. However, the nickel-cadmium battery also has disadvantages. For example, nickel-cadmium batteries cannot keep up with increasing market performance requirements and they are not environmental friendly. Accordingly, there is a need for batteries that have the advantageous properties of nickel-cadmium batteries, but are also environmentally benign.

Another battery technology is the nickel-zinc technology, which has the potential to fulfill various application needs. Nickel-zinc batteries have superior electrochemical properties, which have long been acknowledged and are well documented. For example, in comparison to nickel-cadmium or nickel-metal hydride cells, nickel-zinc cells have higher open circuit voltages (i.e., 1.7 volts vs. 1.4 volts) and potentially can provide significantly higher energy density.

While there are several benefits associated with nickel-zinc batteries, there are also disadvantages. For example, zinc dendrite growth is a common problem in nickel-zinc batteries and is a common source of rechargeable battery failure. It is a phenomenon that occurs during battery recharging, whereby active material, namely, zinc hydroxide Zn(OH)₂, is reduced from its oxidized state and deposited onto a substrate (e.g., electrode being charged) as zinc metal (Zn) Depending on the charging conditions, the metal may be deposited in a dendrite form, and has the potential to penetrate the separator and short the cell by providing an electrical bridge between the negative and positive electrodes. Accordingly, there is a need for zinc batteries that overcome dendrite growth.

Further, zinc electrodes may also be subject to shape change or densification, wherein, through cycling, more active material is deposited typically toward the center of the electrode resulting in a generally convex shape (although on occasions increased zinc deposition has been noted at the corners of zinc electrodes). This results in different current density requirements on different areas of the electrode, reducing efficiency of utilization of active material.

Several attempts have been made to reduce dendrite formation in nickel-zinc batteries. For example, Adler et al. (U.S. Pat. Nos. 5,453,336 and 5,302,475) teach utilizing alkali metal-based fluoride salts and carbonate salts to reduce the shape change of the zinc electrode during recharging. Spaziante et al. (U.S. Pat. No. 4,181,777) disclose an additive such as polysaccharide or sorbitol to prevent zinc dendrite formation during electrical charge of the battery. Berchielli et al. (U.S. Pat. No. 4,041,221) disclose inorganic titanate as an additive in the anode. Rampel (U.S. Pat. No. 3,954,501) discloses enhanced gas recombination, capacity and cycle life in a rechargeable electrolytic cell with the inclusion of a fibrous interconnecting network of an unsintered, uncoalesced, hydrophobic linear fluorocarbon polymer. Collien et al. (U.S. Pat. No. 6,087,030) disclose a zinc anode, including a reaction rate-enabling metal compound such as indium, gallium, germanium, tin, along with aqueous potassium hydroxide. Larsen et al. (U.S. Pat. No. 4,857,424) disclose an alkaline zinc electrochemical cell including a zinc corrosion and hydrogen gas inhibiting quantity of a siliconated, film-forming organic wetting agent. Charkey (U.S. Pat. No. 4,022,953) disclose a zinc electrode structure including cadmium, such as metallic cadmium or a cadmium compound electrochemically convertible to metallic cadmium dispersed in the zinc material, the metallic cadmium having a certain particle dimension and surface area. Charkey et al. (U.S. Pat. No. 5,863,676) disclose use of a calcium-zincate constituent in a zinc electrode. Charkey (U.S. Pat. No. 5,556,720) disclose use of barium hydroxide (Ba(OH)₂)or strontium hydroxide (Sr(OH)₂) material and a conductive matrix including a metallic oxide material which is more electropositive than zinc, such as lead oxide (PbO), bismuth oxide (Bi₂O₃), cadmium oxide (CdO), gallium oxide (Ga₂O₃), or thallium oxide (Tl₂O₃). Charkey (U.S. Pat. No. 4,415,636) disclose cadmium particulate matter dispersed in the zinc material of the anode. Charkey (U.S. Pat. No. 4,332,871) disclose a zinc electrode including a cement additive distributed therein. Schrenk et al. (U.S. Pat. No. 4,791,036) disclose use of an anode current collector made from a silicon bronze alloy for minimizing gassing during overcharging. Lastly, Gibbard et al. (U.S. Pat. No. 4,552,821) disclose a sealed, rechargeable nickel-zinc cell in the form of a wound roll, such that the cell is under compression.

While there are several different approaches in preventing dendrite formation in nickel-zinc batteries, as referenced above, none of the references incorporate a wrapped anode process for jelly-roll structured nickel-zinc batteries. Generally, in battery manufacturing processes, especially in cylindrical batteries, it is unavoidable that some active material drops from cathode or anode or both. When the dropped active material touches the cell can (or in the event that any cathode material touches the anode or any anode material touches the cathode) shorting will occur and gas will be released. Therefore, the battery cell may become useless or even dangerous (if heating occurs from the electrical short or if the cell loses its physical integrity due to excess pressure within the cell). Additionally, separators are often not wrapped around electrodes, merely being disposed between the positive and negative electrodes, wherein the electrodes may contact the cell can.

During charging, the exposed portion of the anode has more tendency to form zinc dendrites. I.e., dendrites grow around the open anode and easily touch the adjacent cathode or even the cell can. If the positive electrode also touches the can a short will occur. Accordingly, there is a need for an effective way to prevent dendrite growth from the exposed portion of the anode.

Therefore, it is readily apparent that there is a need for cells that provide high electrical energy density and that prevents the growth of zinc dendrites and/or shape change, while still maintaining high power density capability and environmental friendliness.

### BRIEF SUMMARY OF THE INVENTION

Briefly described, in a preferred embodiment, the preferred embodiment overcomes the above-mentioned disadvantages and meets the recognized need for such an apparatus by providing a rechargeable zinc cell with a longitudinally-folded separator comprising a zinc negative electrode, a positive electrode, an electrolyte and a separator, wherein the separator is folded longitudinally to wrap under the zinc negative electrode around an edge thereof, and wherein the zinc negative electrode, the positive electrode, the electrolyte and the separator are wound into a jelly roll and contained in a can having a positive terminal connected to the positive electrode and a negative terminal connected to the negative electrode.

According to its major aspects and broadly stated, the preferred embodiment in its preferred form is a rechargeable zinc cell with a longitudinally-folded separator comprising a zinc negative electrode, a positive electrode, an electrolyte and a separator disposed between the electrodes, wherein the separator is folded longitudinally around one edge of the zinc negative electrode. The electrolyte comprises KOH in a range between approximately 1% to approximately 55%, LiOH in a concentration between approximately 0.1% to approximately 30%, KAcet, CsCO₃, In₂(SO₄)₃ and approximately 150 ppm of K₂SnO₃. Alternatively, the electrolyte comprises KOH in a range between approximately 1% to approximately 55%, approximately 15% of CsAcet and 150 ppm of In₂(SO₄)₃.

The separator comprises at least two wicking layers with a microporous layer or other dendrite-blocking separator layer disposed therebetween. The wicking layers comprise a non-woven polypropylene material or a non-woven nylon. The separator is folded over the long dimension of the zinc negative electrode. As such, the zinc negative electrode is completely covered by the separator, such that both sides of the zinc negative electrode are in contact with at least one of the wicking layers of the separator. The positive electrode is disposed on top of the separator and is in contact with one of the wicking layers. The zinc negative electrode, the positive electrode, the electrolyte and the separator are then rolled together to form a jelly roll such that the portion of the separator wrapped under the long edge of the electrode is at the bottom of the jelly roll. The jelly roll comprises a negative terminal in electrical communication with the zinc negative electrode and a positive terminal in electrical communication with the positive electrode. The jelly roll is contained in a can having a cover insulated from the can by a seal ring. The negative terminal is in electrical communication with the cover and the positive terminal is in electrical communication with the can. The separator is folded along the long edge of the zinc negative electrode to insulate the zinc negative electrode from the can.

Additionally, the preferred embodiment is a method of constructing a rechargeable zinc cell with a longitudinally-folded separator. The method comprises the steps of obtaining a zinc negative electrode, a positive electrode, an electrolyte and a separator having two wicking layers with a microporous layer or other dendrite blocking layer disposed therebetween. The zinc negative electrode is placed in contact with one of the wicking layers of the separator, such that a first side of the zinc negative electrode is fully covered by the separator. The separator is then longitudinally folded around along the long edge of the zinc negative electrode. A positive electrode is then placed on the separator/negative electrode stack. The negative electrode, the positive electrode and the separator are then wound into a jelly roll structure. The jelly roll structure comprises a negative terminal in electrical communication with the zinc negative a positive terminal in electrical communication with the positive electrode. The jelly roll structure is then placed into a cell housing comprising a can, a seal and a cover. Additionally, the preferred embodiment is a rechargeable cell further containing KAcet.

More specifically, the prior art teaches a configuration comprising a generally rectangular zinc negative electrode and a separator. The zinc negative electrode comprises a first end, a second end, a first edge, a second edge, a front surface, a back surface and a tab. The separator is generally rectangular in shape and comprises a top half, a bottom half, a first edge, a second edge, a fold line, a first end and a second end. The separator further comprises a wicking layer. The zinc negative electrode is disposed on the bottom half of the separator, wherein the second end of the zinc negative electrode is proximate the second end of the separator. The back surface of the zinc negative electrode is in contact with the wicking layer of the separator. The prior art embodiment teaches folding the separator along the fold line with the first end disposed, after folding, proximate the second end of the separator, such that the separator extends beyond the outer dimensions of the zinc negative electrode, and the tab extends beyond the separator.

It will be noted that in the prior art configuration the first edge and the second edge of the zinc negative electrode are open to contact externally because the top half and the bottom half of the separator merely cover, but do not seal, the first and second edge of the zinc negative electrode. Accordingly, the first and second edges of the zinc negative electrode may move beyond the first and second edges of the separator and thereby make contact with an external container once the electrodes are wound and placed in a cell. Further, loose material from the zinc negative electrode may migrate beyond the first and second edges of the separator and provide electrical communication between the zinc negative electrode and any container therearound.

It will be recognized by those skilled in the art that the zinc negative electrode may be made by techniques known in the art. For example, a powdered mixture of the desired materials and a binder may be rolled onto a suitable current collector, such as, for exemplary purposes only, a copper screen. Prior techniques have utilized calcium hydroxide as a further component of the negative electrode mixture. However, it is not necessary to include calcium hydroxide in the preferred embodiment and it is preferred that the zinc negative electrode is essentially free of calcium hydroxide. Additionally, it should be recognized by those skilled in the art that a variety of housing materials for fabricating zinc electrode is known, wherein typically, the binder material utilized is inert in the cell environment and is incorporated in an amount sufficient to hold the mixture together.

The preferred embodiment is a configuration comprising a zinc negative electrode and a separator. The zinc negative electrode comprises a first end, a second end, a first edge, a second edge, a front surface, a back surface and a tab. The separator comprises two wicking layers with a microporous layer or other dendrite blocking separator layer disposed therebetween. The separator also comprises a longitudinal fold line, a first edge, a second edge, a first end, a second end, a front surface and a back surface. The longitudinal fold line is approximately parallel and disposed between the first edge and the second edge of the separator. The zinc negative electrode is disposed on the front surface of the separator between the longitudinal fold line and the second edge of the separator. The first edge of the zinc negative electrode is disposed approximately parallel to the longitudinal fold line of the separator. The separator is folded along the longitudinal folding line such that the first edge of the separator is disposed proximate the second edge of the separator. Thus, the front surface and the back surface of the zinc negative electrode are in contact with one of the wicking layers. Accordingly, the separator extends past the first end, the second end, the first edge, the second edge of the negative electrode, and the tab of the zinc negative electrode extends beyond the first edge and the second edge of the separator.

It will be noted that, contrary to the prior art embodiment discussed herein above, the preferred embodiment results in the first edge of the zinc negative electrode being completely surrounded by the separator. As such, the first edge can no longer contact a container once the electrodes and separator are wound and placed in a cell. Further, any material that sloughs off the first edge will be retained in the longitudinal fold line and can no longer provide electrical communication between the zinc negative electrode and any container therearound.

The material utilized for the separator should comprise a membrane having relatively fine, uniformly-sized pore structure to preferably facilitate wicking and electrolyte permeation therethrough, while reducing or eliminating dendrite penetration therethrough. The material employed should possess sufficient flexibility and strength characteristics to endure adequately any shape change and/or electrode expansion, and for the preferred embodiment a composite membrane is utilized comprising two the wicking layers on either side of a microporous layer. As one illustrative example, without limitation, the microporous layer may comprise commercially available CELGARD polypropylene film, while the wicking layers could comprise non-woven nylon or polypropylene material.

The preferred embodiment further comprises a separator membrane formed from at least two polymers impregnated into a non-woven substrate, wherein the at least two polymers form an interpenetrating matrix network. The polymers comprise, for exemplary purposes only, PVA or fluoro-substituted PVA as a first polymer, and a water soluble, KOH insoluble, film-forming polymer as a second polymer, wherein the second polymer comprises, for exemplary purposes only, polymeric acids sulphates, phosphates and their cationic salts. An alternate embodiment could further include nanosized particles that are insoluble in potassium hydroxide.

As a further illustrative example, without limitation, it is satisfactory to utilize an aqueous potassium hydroxide solution containing approximately 10% to 30% by weight of potassium hydroxide (KOH), optionally approximately 1% by weight of lithium hydroxide (LiOH), approximately 5% by weight of potassium acetate (KAcet), approximately 5% by weight of cesium carbonate CsCO₃, between 8% and 15% by weight of cesium acetate (CsAcet), approximately 150 ppm of potassium stannate (K₂SnO₃)and approximately between 150 and 200 ppm of indium sulphate In₂(SO₄)₃. It is desirable to utilize initially an electrolyte saturated with zinc oxide (ZnO) so as to suppress initial dissolution of zinc oxide from the electrode into the electrolyte. As is known in the sealed electrochemical cell art, the amount of electrolyte utilized should be restricted sufficiently so that an effective oxygen recombination reaction will be provided at the zinc electrode. In the preferred embodiment, the necessary electrolyte can be added to the open space in the core of the jelly roll wound cell element prior to the sealing of the cell.

A positive electrode comprises a first end, a second end, a first edge, a bottom edge, a front surface, a back surface and a tab. The positive electrode is disposed onto the construction, wherein the construction comprises the configuration of the separator longitudinally folded around the zinc negative electrode. The first edge of the positive electrode is approximately parallel the longitudinal folding line. The tab of positive electrode extends beyond the longitudinal fold line of the separator. The tab is disposed near the longitudinal fold line, such that the tab of the positive electrode and the tab of the zinc negative electrode are on opposite sides of the construct. The back surface of the positive electrode is in contact with the wicking layer of the separator, such that the construct is wound into a jelly roll, such that the back surface of the positive electrode is in contact with the wicking layer of the positive electrode, and nearly all of the front surface of the positive electrode is in contact with the wicking layer of the positive electrode. It should be recognized that the preferred embodiment comprises the zinc negative electrode and the positive electrode being in contact with the wicking layers serve to impart longer cell life cycle, particularly at high discharge rates of about 2 C or higher.

The negative electrode, the separator and the positive electrode are rolled together to form a jelly roll. The jelly roll is contained in housing, thereby forming a cell. The jelly roll comprises the zinc negative electrode, the positive electrode, the separator, a top and a bottom. The top comprises the tab of zinc negative electrode and the bottom comprises the tab of positive electrode. The bottom is formed along the longitudinal folding line, and the separator comprises the wicking layers and the microporous layer. The housing comprises a can, a seal and a cover. The cover comprises a negative terminal and the can comprises a positive terminal. The bottom of the jelly roll is disposed proximate the bottom of the can, such that the positive electrode tab is connected to the positive terminal, such as via, for exemplary purposes only, welding. Similarly, the top of the jelly roll is disposed proximate the cover, and the tab is connected to the cover forming a negative terminal, such as via, for exemplary purposes only, welding. It should be recognized by those skilled in the art that the preferred embodiment comprises the negative terminal disposed proximate the top of the housing to prevent the zinc negative electrode from contacting the housing. It should also be recognized in the art that the cell of the preferred embodiment may be utilized in either prismatic or cylindrical design, as desired for the particular application. Likewise, capacity of the cell may vary within wide limits, the size being dictated by the requirements of the particular application. As one example, a cylindrical sub-C size cell may suitably have a capacity of, for example, 1.5 Ampere-hours.

Additionally, the preferred embodiment allows extended cycle life of cells. As depicted, the discharge capacity of the cells of this invention is maintained substantially higher than the discharge capacity of a conventional nickel-zinc cell up to one hundred cycles or more.

Lastly, the zinc negative electrode tab is connected to the cover to reduce metal surface area in electrical communication with the zinc electrode, thereby reducing generation of hydrogen gas, which does not readily recombine within the cell. If hydrogen gas is generated, having no place to recombine, pressure within the cell will increase, leading to possibly hazardous consequences. Accordingly, in the preferred embodiment, the zinc negative electrode is in electrical communication with the cover and the positive electrode is in electrical communication with the can. Oxygen gas generated at the positive electron near end of charge and in overcharge readily combines at the zinc electrode under optimal conditions, thereby reducing the tendency for excess pressure due to oxygen.

Accordingly, a feature and advantage of the preferred embodiment is its ability to effectively prevent dendrite growth.

Another feature and advantage of the preferred embodiment is its ability to provide improved electrical performance and life cycle.

Another feature and advantage of the preferred embodiment is its ability to be simply constructed and economically manufactured.

Still another feature and advantage of the preferred embodiment is its ability to operate at high current levels.

Yet another feature and advantage of the preferred embodiment is its ability to stand for prolonged periods of time in a discharged condition without undue internal pressure build-up.

Yet still another feature and advantage of the preferred embodiment is its long life cycle.

A further feature and advantage of the preferred embodiment is its ability to provide higher discharge capacity than conventional nickel-zinc cells up to one hundred cycles or more.

Yet another feature and advantage of the preferred embodiment is its inclusion of wicking layers on the separator adjacent both positive and negative electrode layers, thereby increasing cell life cycle and cell capacity.

These and other features and advantages of the preferred embodiment will become more apparent to one skilled in the art from the following description and claims when read in light of the accompanying drawings.

### BRIEF DESCRIPTION OF THE SEVERAL VIEWS OF THE DRAWINGS

The preferred embodiment will be better understood by reading the Detailed Description of the Preferred Embodiments with reference to the accompanying drawing figures, in which like reference numerals denote similar structure and refer to like elements throughout, and in which:

FIG. 1A is perspective view of a separator and a zinc negative electrode, shown with the folding direction commonly utilized in prior art cylindrical cells;

FIG. 1B is a perspective view of separator and zinc negative electrode components according to a preferred embodiment of a rechargeable cell with longitudinally wrapped zinc negative electrode, shown with the folding direction of the separator along the long edge of the zinc negative electrode;

FIG. 1C is a perspective view of the preferred embodiment, shown with the separator folded around the zinc negative electrode;

FIG. 2A is a perspective view of a positive electrode disposed on the configuration of FIG. 1C;

FIG. 2B is a perspective cross-sectional view of an assembled cell according to a preferred embodiment, illustrating the jelly roll internal configuration of the separator and the electrodes; and

FIG. 3 is a graph illustrating the charging and discharging capacity of a cell wrapped with a zinc electrode according to the preferred embodiment, compared to the charging and discharging capacity of a cell with a zinc electrode wrapped according to the prior art of FIG. 1A.

### DETAILED DESCRIPTION OF THE PREFERRED AND SELECTED ALTERNATE EMBODIMENTS OF THE INVENTION

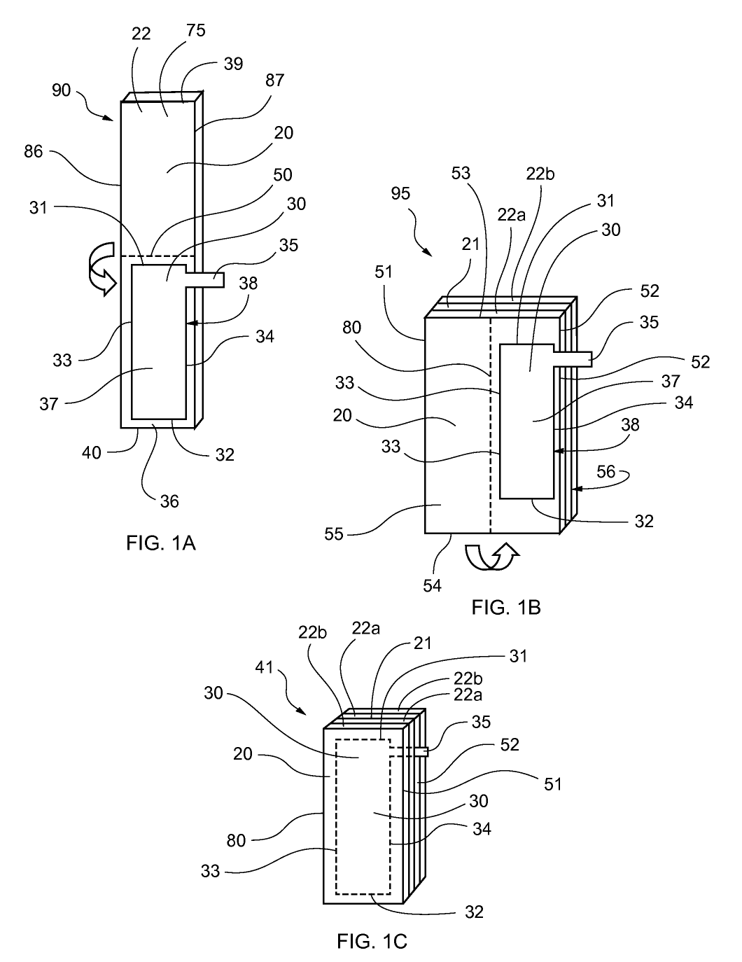

In describing the preferred and selected alternate embodiments of the preferred embodiment, as illustrated in FIGS. 1A-3, specific terminology is employed for the sake of clarity. The invention, however, is not intended to be limited to the specific terminology so selected, and it is to be understood that each specific element includes all technical equivalents that operate in a similar manner to accomplish similar functions.

Referring to FIG. 1A, depicted therein is a prior art embodiment, wherein configuration 90 comprises zinc negative electrode 30 and separator 20, and wherein zinc negative electrode 30 is generally rectangular in shape and comprises first end 31, second end 32, first edge 33, second edge 34, front surface 37, back surface 38 and tab 35. Separator 20 is generally rectangular in shape and comprises top half 75, bottom half 36, first edge 86, second edge 87, fold line 50, first end 39 and second end 40, wherein separator 20 further comprises wicking layer 22. Zinc negative electrode 30 is disposed on bottom half 36 of separator 20, wherein second end 32 of zinc negative electrode 30 is proximate second end 40 of separator 20, and wherein back surface 38 of zinc negative electrode 30 is disposed in contact with wicking layer 22 of separator 20. The prior art embodiment teaches folding separator 20 along fold line 50, wherein after folding, first end 39 of separator 20 is disposed proximate second end 40 of separator 20, and wherein separator 20 extends beyond the outer dimensions of zinc negative electrode 30, and wherein tab 35 extends beyond separator 20.

It will be noted that in the prior art configuration of FIG. 1A, first edge 33 and second edge 34 of zinc negative electrode 30 are open to contact externally because top half 75 of separator 20 and bottom half 36 of separator 20 merely cover, but do not seal, first edge 33 and second edge 34 of zinc negative electrode 30. Accordingly, first edge 33 and second edge 34 of zinc negative electrode 30 may move beyond first and second edges 86, 87 of separator 20 and may thereby make contact with an external container once the electrodes are wound and placed in a cell. Further, loose material from zinc negative electrode 30 may migrate beyond first and second edges 86, 87 of separator 20 and provide undesirable electrical communication between zinc negative electrode 30 and any container therearound.

It will be recognized by those skilled in the art that zinc negative electrode 30 may be made by techniques known in the art. For example, without limitation, a powdered mixture of the desired materials, typically zinc metal and zinc oxide, and a binder may be rolled onto a suitable current collector, such as, for exemplary purposes only, a copper screen. Prior techniques have utilized calcium hydroxide as a further component of the negative electrode mixture. However, it is not necessary to include calcium hydroxide in the preferred embodiment and it is preferred that zinc negative electrode 30 is essentially free of calcium hydroxide. Additionally, it should be recognized by those skilled in the art that a variety of materials for fabricating zinc electrode is known, wherein typically, the binder material utilized is inert in the cell environment and is incorporated in an amount sufficient to hold the mixture together.

Referring now to FIGS. 1B-1C, depicted therein is a preferred embodiment comprising configuration 95, wherein configuration 95 comprises zinc negative electrode 30 and separator 20, and wherein zinc negative electrode 30 comprises first end 31, second end 32, first edge 33, second edge 34, front surface 37, back surface 38 and tab 35. Separator 20 comprises two wicking layers 22a and 22b with microporous layer 21 disposed therebetween, longitudinal fold line 80, first edge 51, second edge 52, first end 53, second end 54, front surface 55 and back surface 56, wherein longitudinal fold line 80 is approximately parallel and disposed between first edge 51 and second edge 52 of separator 20. It will be recognized that other dendrite blocking separator layers could be substituted for the microporous layer 21 without departing from the spirit of the preferred embodiment.

Zinc negative electrode 30 is disposed on front surface 55 of separator 20 between longitudinal fold line 80 and second edge 52 of separator 20, wherein first edge 33 of zinc negative electrode 30 is disposed approximately parallel to and proximate longitudinal fold line 80 of separator 20. Separator 20 is folded along longitudinal folding line 80 such that first edge 51 of separator 20 is disposed proximate second edge 52 of separator 20, wherein both front surface 37 and back surface 38 of zinc negative electrode 20 are thus in contact with wicking layer 22a. As best shown in FIG. 1C, separator 20 extends past first end 31, second end 32, first edge 33 and second edge 34 and separator 20 folds over first edge 33 of negative electrode 30, wherein tab 35 of negative electrode 30 extends beyond first edge 51 and second edge 52 of separator 20, thereby forming construct 41.

It will be noted that, contrary to the prior art embodiment discussed herein above, the preferred embodiment results in first edge 33 of zinc negative electrode 30 being completely surrounded by separator 20, wherein first edge 33 can no longer contact a container once the electrodes and separator are wound and placed in a cell. Further, any material that sloughs off first edge 33 of zinc negative electrode 30 will be retained in longitudinal fold line 80 and can no longer provide electrical communication between zinc negative electrode 30 and any container therearound.

The material utilized for separator 20 comprises a membrane having relatively fine, uniformly-sized pore structure to preferably facilitate wicking and electrolyte permeation therethrough, while reducing or eliminating dendrite penetration therethrough. The material employed should possess sufficient flexibility and strength characteristics to endure adequately any shape change and/or electrode expansion, and for the preferred embodiment, a composite membrane is utilized comprising two wicking layers 22a, 22b on either side of microporous layer 21. As one illustrative example, without limitation, microporous layer 21 may comprise commercially available CELGARD polypropylene film, while wicking layers 22a, 22b could comprise non-woven nylon or polypropylene material.

As a further illustrative example, without limitation, it is satisfactory to utilize an aqueous potassium hydroxide solution containing approximately 10% to 30% by weight of potassium hydroxide (KOH), optionally approximately 1% by weight of lithium hydroxide (LiOH), approximately 5% by weight of potassium acetate (KAcet), approximately 5% by weight of cesium carbonate CsCO₃, between 8% and 15% by weight of cesium acetate (CsAcet), approximately 150 ppm of potassium stannate (K₂SnO₃) and approximately between 150 and 200 ppm of indium sulphate In₂(SO₄)₃. It is desirable to utilize initially an electrolyte saturated with zinc oxide (ZnO) so as to suppress initial dissolution of zinc oxide from the electrode into the electrolyte. As is known in the sealed electrochemical cell art, the amount of electrolyte utilized should be restricted sufficiently so that an effective oxygen recombination reaction will be provided at the zinc electrode. In the preferred embodiment, the necessary electrolyte can be added to the open space in the core of the jelly roll wound cell element prior to the sealing of the cell.

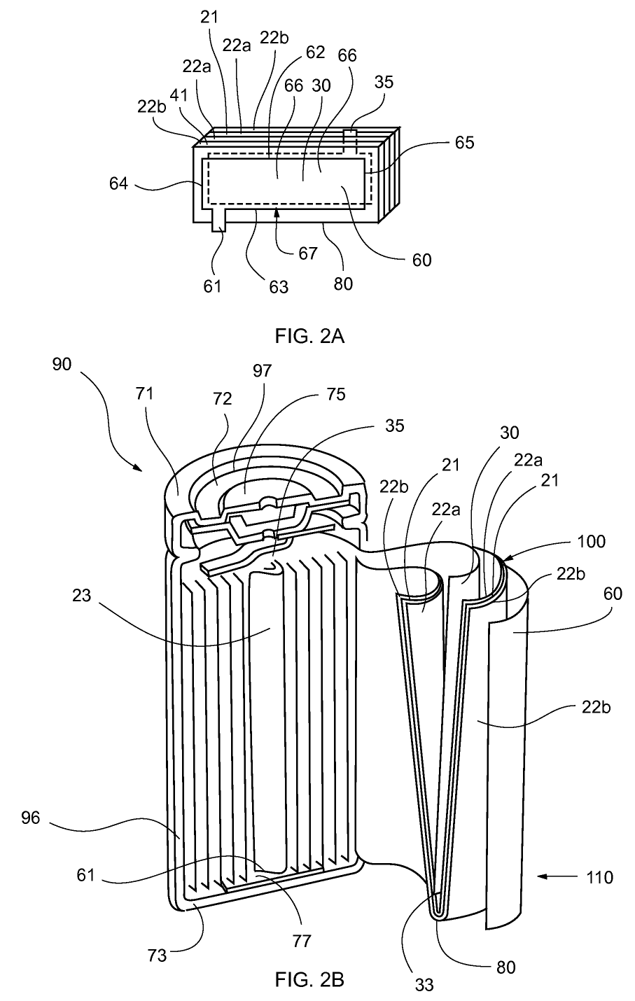

Referring now to FIG. 2A, positive electrode 60 comprises first end 64, second end 65, first edge 63, second edge 62, front surface 66, back surface 67 and tab 61. Positive electrode 60 is disposed onto construct 41, wherein construct 41 comprises the configuration of FIG. IC. First edge 63 is approximately parallel longitudinal folding line 80, wherein tab 61 extends beyond longitudinal fold line 80 of separator 20, and wherein tab 61 of positive electrode 60 and tab 35 of zinc negative electrode 30 are on opposite sides of construct 41. Back surface 67 of positive electrode 60 is thus in contact with wicking layer 22b of separator 20, wherein once the construction of FIG. 2A is wound into a jelly roll as best shown in FIG. 2B, back surface 67 is in the full contact with wicking layer 22b of separator 20, and nearly all of front surface 66 is in contact with wicking layer 22b of separator 20. It should be recognized that the preferred embodiment comprises zinc negative electrode 30 in contact with wicking layer 22a and nearly all positive electrode 60 in contact with wicking layer 22b, thereby serving to impart longer cell life cycle, particularly at high discharge rates of about 2 C or higher.

Referring now to FIG. 2B, negative electrode 30, separator 20 and positive electrode 60 are rolled together to form jelly roll 23, which is contained in housing 71, thereby forming cell 90. Jelly roll 23 comprises zinc negative electrode 30, positive electrode 60, separator 20, first end 100 and second end 110, wherein first end 100 comprises tab 35, and wherein second end 110 comprises tab 61, and wherein second end 110 is formed along longitudinal folding line 80. Housing 71 comprises can 96, seal ring 97 and cover 72, wherein cover 72 comprises negative terminal 75, and wherein can 96 comprises bottom 73 forming positive terminal 77. Second end 110 of jelly roll 23 is disposed proximate bottom 73 of can 96, wherein tab 61 is connected to positive terminal 77, such as via, for exemplary purposes only, welding. Similarly, first end 100 of jelly roll 23 is disposed proximate cover 72 of housing 71, wherein tab 35 is connected to negative terminal 75, such as via, for exemplary purposes only, welding. It should be recognize by those skilled in the art that the preferred embodiment comprises negative terminal 75 in electrical communication with tab 35 to prevent zinc negative electrode 30 from contacting can 96. It should also be recognized in the art that cell 90 of the preferred embodiment may be utilized in either prismatic or cylindrical design, as desired for the particular application. Likewise, capacity of the cell may vary within wide limits, the size being dictated by the requirements of the particular application. As one example, a cylindrical sub-C size cell may suitably have a capacity of, for example, 1.5 Ampere-hours.

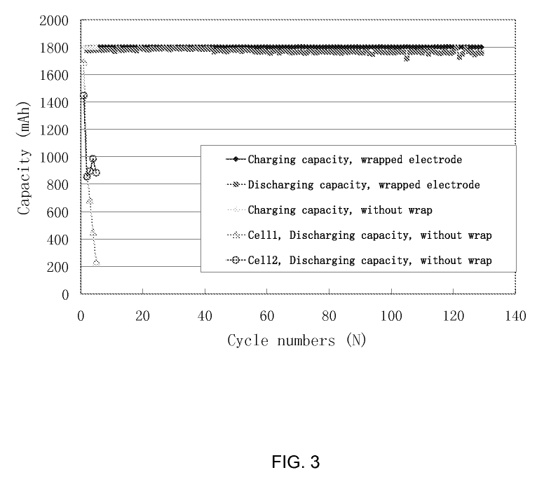

As best shown in FIG. 3, the preferred embodiment allows extended cycle life of cells. As depicted, the discharge capacity of the cells of the preferred embodiment is maintained substantially higher than the discharge capacity of a conventional nickel-zinc cell up to one hundred cycles or more.

Zinc negative electrode 30 is in electrical communication with cover 72 to reduce generation of hydrogen gas, which does not readily combine within the cell, by minimizing the metal surface area which is in electrical communication with zinc negative electrode 30. (If hydrogen gas is generated, having no place to recombine, pressure within the cell will increase, leading to possibly hazardous consequences. Accordingly, the preferred embodiment is in electrical communication to the cover of the positive electrode of the can. Oxygen gas readily combines at the zinc electrode under optimal conditions, thereby reducing the tendency for excess pressure due to oxygen.)

In an alternative embodiment cover 70 could comprise triclad material of nickel on the outside, steel in the middle and copper on the inside of cover 70, wherein the copper can be plated with tin, zinc, indium or combinations thereof, to reduce the microcell effect, which could cause the gassing of zinc electrode 30.

In another alternate embodiment, cover 70 could be coated with polymer resin, including but not limited to, epoxy resin, to further reduce the heterogeneous metal contact in the presence of electrolyte and thereby reduce hydrogen gassing.

The foregoing description and drawings comprise illustrative embodiments of the preferred embodiment. Having thus described exemplary embodiments of the preferred embodiment, it should be noted by those skilled in the art that the within disclosures are exemplary only, and that various other alternatives, adaptations, and modifications may be made within the scope of the preferred embodiment. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the preferred embodiment is not limited to the specific embodiments illustrated herein, but is limited only by the following claims.

What is claimed is:

1. A rechargeable zinc cell with a longitudinally-folded separator, said rechargeable cell comprising:
a zinc negative electrode;
a positive electrode;
an electrolyte; and
a separator disposed between said electrodes, wherein said separator is folded longitudinally around one edge of said zinc negative electrode.

2. The rechargeable zinc cell with a longitudinally-folded separator of claim 1, wherein said electrolyte comprises KOH in a range between approximately 1% to approximately 55%.

3. The rechargeable zinc cell with a longitudinally-folded separator of claim 2, wherein said electrolyte further comprises KAcet, CsCO₃ and In₂(SO4)₃.

4. The rechargeable zinc cell with a longitudinally-folded separator of claim 3, wherein said electrolyte further comprises K₂SnO₃.

5. The rechargeable zinc cell with a longitudinally-folded separator of claim 3, wherein said electrolyte further comprises 150 ppm of K₂SnO₃.

6. The rechargeable zinc cell with a longitudinally-folded separator of claim 2, wherein said electrolyte further comprises CsAcet and In₂(SO₄)₃.

7. The rechargeable zinc cell with a longitudinally-folded separator of claim 2, wherein said electrolyte further comprises 15% CsAcet and 150 ppm of In₂(SO₄)₃.

8. The rechargeable zinc cell with a longitudinally-folded separator of claim 1, wherein said separator comprises two wicking layers with at least one microporous layer disposed therebetween.

9. The rechargeable zinc cell with a longitudinally-folded separator of claim 8, wherein said separator is folded over said zinc negative electrode along a long dimension thereof, and wherein said zinc negative electrode is completely covered by said separator, and wherein both sides of said zinc negative electrode are in contact with one of said wicking layers.

10. The rechargeable zinc cell with a longitudinally-folded separator of claim 9, wherein said positive electrode is disposed on top of said folded separator and is in contact with another of said wicking layers.

11. The rechargeable zinc cell with a longitudinally-folded separator of claim 1, wherein said zinc negative electrode, said positive electrode, said electrolyte and said separator are rolled together to form a jelly roll.

12. The rechargeable zinc cell with a longitudinally folded separator of claim 11, wherein said jelly roll comprises a negative terminal in electrical communication with said zinc negative electrode and a positive terminal in electrical communication with said positive electrode.

13. The rechargeable zinc cell with a longitudinally-folded separator of claim 12, wherein said jelly roll is contained in a can having a cover insulated from said can by a seal ring.

14. The rechargeable zinc cell with a longitudinally-folded separator of claim 13, wherein said negative terminal is in electrical communication with said cover, and wherein said positive terminal is in electrical communication with said can.

15. The rechargeable zinc cell with a longitudinally-folded separator of claim 12, wherein said separator is folded along the long edge of said zinc negative electrode to insulate said zinc negative electrode from said can.

16. The rechargeable zinc cell with a longitudinally-folded separator of claim 2, further comprising LiOH in a concentration between approximately 0.1% to approximately 30%.

17. The rechargeable zinc cell with a longitudinally-folded separator of claim 8, wherein said wicking layers each comprise a material selected from the group consisting of a non-woven polypropylene material and a non-woven nylon, and combinations thereof.

18. A method of constructing a rechargeable zinc cell with a longitudinally-folded separator, said method comprising the steps of:
obtaining a zinc negative electrode, a positive electrode, an electrolyte and a separator, wherein said separator comprises two wicking layers with a microporous layer disposed therebetween;
placing said zinc negative electrode in contact with one of said two wicking layers of said separator, wherein a first side of said zinc negative electrode is fully covered by said separator;
folding said separator longitudinally around a long edge of said zinc negative electrode;
placing said positive electrode on said folded separator in contact with the other of said two wicking layers; and
rolling said zinc negative electrode, said positive electrode and said separator into a jelly roll structure, wherein said jelly roll structure comprises a negative terminal in electrical communication with said zinc negative electrode and a positive terminal in electrical communication with said positive electrode.

19. The method of constructing a rechargeable zinc cell with a longitudinally-folded separator of claim 18, said method further comprising the steps of:
placing said jelly roll structure into a cell housing comprising a can, a seal and a cover.

20. A rechargeable zinc cell with a longitudinally-folded separator, said rechargeable zinc cell comprising:
a zinc electrode comprising two ends and two long edges;
a separator folded along one of said two long edges of said zinc electrode, wherein said separator covers both sides of said zinc electrode; and
an electrolyte comprising KAcet.
